(19) United States
(12) Patent Application Publication
(10) Pub. No.: US 2021/0227078 A1
(43) Pub. Date: Jul. 22, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Kengo TOKUCHI, Kanagawa (JP); Naoyasu TERAO, Kanagawa (JP)

(73) Assignee: FUJI XEROX CO., LTD., Tokyo (JP)

(21) Appl. No.: 16/998,107

(22) Filed: Aug. 20, 2020

(30) Foreign Application Priority Data
Jan. 16, 2020 (JP) 2020-005447

(51) Int. Cl. H04M 15/00; H04W 4/24; G06Q 40/06

(52) U.S. Cl. CPC H04M 15/54; H04M 15/88; H04M 2215/32; H04W 4/24; G06Q 40/06; H04M 15/8083

(57) ABSTRACT

An information processing apparatus includes a processor configured to calculate allocations of a profit from a service to a plurality of entities involved in provision of the service by referring to involvement information stored in a memory, the involvement information indicating involvement of each of the plurality of entities in the provision of the service, and output the calculated allocations.

### CROSS-REFERENCE TO RELATED APPLICATIONS

This application is based on and claims priority under 35 USC 119 from Japanese Patent Application No. 2020-005447 filed Jan. 16, 2020.

### BACKGROUND

### (i) Technical Field

The present disclosure relates to an information processing apparatus and a non-transitory computer readable medium.

### (ii) Related Art

International Publication No. 2015/129864 describes a management server that can communicate with plural photographing amusement machines operated by different entities, each of which transmits at least image information on an image taken by a user by using the photographing amusement machine. The management server includes an information accumulation unit that accumulates therein image information transmitted from the photographing amusement machine in association with identification information of an entity that operates the photographing amusement machine used by the user and an earnings allocation determining unit that reads out the information stored in the information accumulation unit and determines allocations, to the entities, of entire earnings or part of the earnings obtained by offering the image information accumulated in the information accumulation unit to the user by performing statistical processing on the image information.

### SUMMARY

Plural entities may be involved with a sharing service for allowing plural users to use a single space in different time windows. For example, an entity that offers a place, an entity that offers equipment necessary for sharing of the place, and an entity that manages the service may be involved with the sharing service. In such a sharing service with which plural entities are involved, it is desirable to distribute a profit obtained from end users among the plural entities in accordance with degrees of the involvement with the service.

Aspects of non-limiting embodiments of the present disclosure relate to an information processing apparatus and a non-transitory computer readable medium that properly calculate allocations of a profit to entities involved with a sharing service.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to calculate allocations of a profit from a service to a plurality of entities involved in provision of the service by referring to involvement information stored in a memory, the involvement information indicating involvement of each of the plurality of entities in the provision of the service, and output the calculated allocations.

### BRIEF DESCRIPTION OF THE DRAWINGS

An exemplary embodiment of the present disclosure will be described in detail based on the following figures, wherein:

FIG. 1 illustrates an outline of a sharing service according to the present exemplary embodiment;

FIG. 2 illustrates an example of a configuration of a system for offering the sharing service according to the present exemplary embodiment;

FIG. 3 illustrates a relationship between work booths and users;

FIG. 4 illustrates an example of a sharing service operation model;

FIG. 5 illustrates an example of a sharing service operation model;

FIG. 6 illustrates an example of a sharing service operation model;

FIG. 7 illustrates an example of a sharing service offering scenario;

FIG. 8 illustrates an example of a sharing service offering scenario;

FIG. 9 is a block diagram illustrating a hardware configuration of a service operation management system;

FIG. 10 is a block diagram illustrating an example of a functional configuration of the service operation management system;

FIG. 11 is a flowchart illustrating flow of allocation calculation processing performed by the service operation management system.

FIG. 12 is an example of a user interface offered so that the service operation management system calculates allocations and rates of the allocations;

FIG. 13 is an example of a user interface offered so that the service operation management system calculates allocations and rates of the allocations;

FIG. 14 illustrates an example of a sharing service operation scenario;

FIG. 15 is an example of a user interface of a discount tool offered by the service operation management system; and

FIG. 16 is an example of a user interface of the discount tool offered by the service operation management system.

### DETAILED DESCRIPTION

An exemplary embodiment of the present disclosure is described below with reference to the drawings. Identical or equivalent constituent elements and parts in the drawings are given identical reference signs. Dimensional ratios in the drawings are exaggerated for convenience of description and may be different from actual ratios.

The exemplary embodiment of the present disclosure relates to a technique used in a sharing service for allowing plural users to use a single space in different time windows. Examples of the single space include a work booth installed in a form of an individual room, a rental conference room, a table at a restaurant, and a combination of a parking area and a rental car. The following description discusses an example in which the space is a work booth installed in a form of an individual room. The “work booth” encompasses various kinds of work booth from a small work booth for a single person to a large work booth for plural persons and is not limited to specific one.

Such a sharing service may be operated by a single entity or may be operated by plural entities. For example, an entity that offers a place, an entity that offers equipment necessary for sharing of the place, and an entity that manages the service are involved with the sharing service. The present exemplary embodiment provides a technique used in a sharing service with which plural entities are involved.

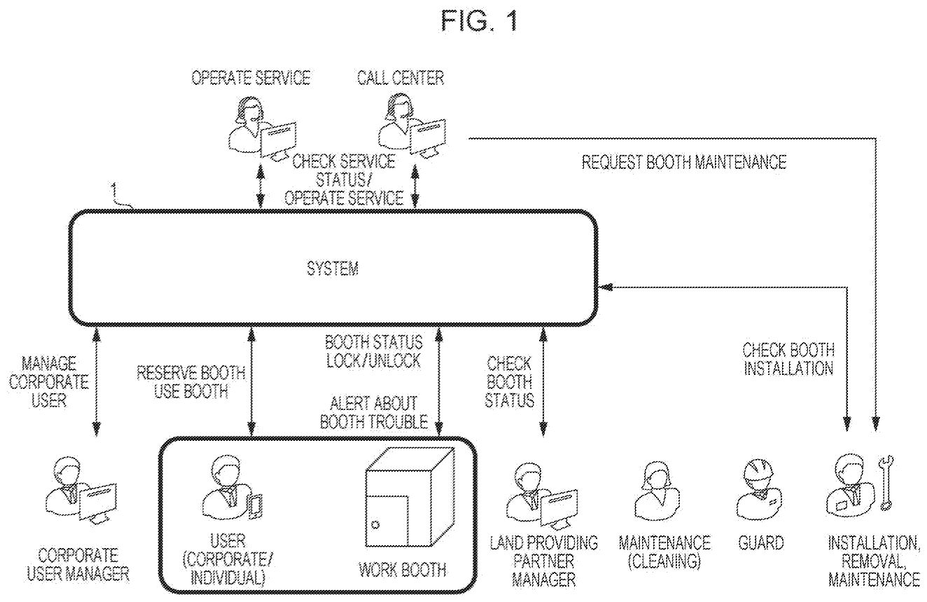

FIG. 1 illustrates an outline of a sharing service according to the present exemplary embodiment. FIG. 1 illustrates users of a system 1 for offering the sharing service. The users of the system 1 can include a service provider that operates the sharing service, a call center that checks a service status and responds to inquiries, and users (general users and corporate users) of the sharing service. Furthermore, the users of the system 1 can include a maintenance entity that is in charge of installation, removal, and maintenance of a work booth or equipment in the work booth, a security guard who guards the work booth, and a cleaning personnel who cleans the inside of the work booth. Furthermore, the users of the system 1 can include a manager of land providing partner that provides and manages a place for the sharing service and checks a use status of the work booth through the system 1.

The system 1 controls the work booth. For example, the system 1 controls locking and unlocking of a key of a door of the work booth and devices such as a surveillance camera, a microphone, a monitor, and an air-conditioner placed in the work booth. Furthermore, the system 1 receives an alert about a trouble that occurs in the work booth.

The call center requests the entity that is in charge of installation, removal, and maintenance of the equipment in the work booth to do maintenance of the work booth. Examples of the maintenance of the work booth can include checking of operation of equipment placed in the work booth and replenishment of articles.

As described above, in a case where plural entities are involved with a single sharing service, these entities are involved with the sharing service in various ways. It is therefore desirable to take involvement of the entities with the sharing service into consideration when dividing a profit obtained from users among the entities.

The present exemplary embodiment describes a technique for properly calculating allocations of a profit obtained from users on the basis of involvement information, which is information on involvement with a sharing service, in a case where plural entities are involved with the sharing service as illustrated in FIG. 1.

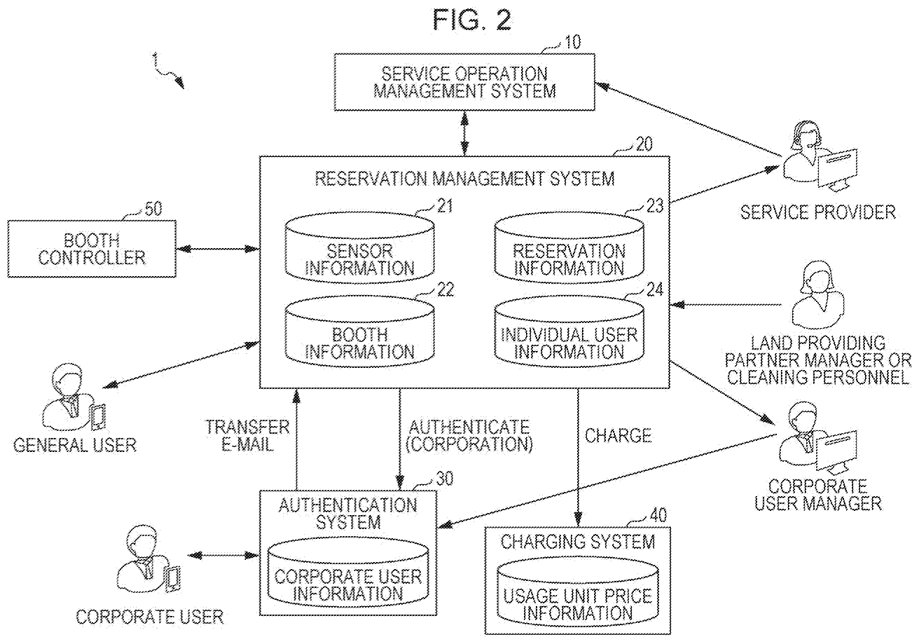

FIG. 2 illustrates an example of a configuration of the system 1 for offering a sharing service according to the present exemplary embodiment. The system 1 includes a service operation management system 10, a reservation management system 20, an authentication system 30, a charging system 40, and a booth controller 50. The systems may be realized by one or more servers. The service operation management system 10, the reservation management system 20, the authentication system 30, the charging system 40, and the booth controller 50 may be constructed on respective different servers or two or more systems may be constructed on an identical server.

The service operation management system 10 is a system that is mainly used by the service provider that operates the sharing service and supports operation of the work booth by the service provider. The service provider is an example of an entity that operates the sharing service. The service provider inquires of the service operation management system 10 about reservation information on a reservation of the work booth and information on a user using the sharing service. Furthermore, the service operation management system 10 has a function of calculating allocations and allocation rates of a profit to entities involved with the sharing service.

The reservation management system 20 is a system that manages reservations of the work booth made by users (general users and corporate users) of the sharing service. The reservation management system 20 is also used by a manager of a corporate user to check a status of use of the work booth. The work booth can also be reserved by a land partner manager or a cleaning personnel by using the reservation management system 20. Furthermore, the reservation management system 20 manages a status of the work booth and, upon occurrence of an abnormality in the work booth, notifies the service provider about occurrence of the abnormality.

The reservation management system 20 holds therein sensor information 21, booth information 22, reservation information 23, and individual user information 24.

The sensor information 21 is information on various sensors placed in the work booth. The work booth may be provided with sensors such as a door opening/closing sensor, an illuminance sensor, and a human sensor. Furthermore, the work booth may be provided with a surveillance camera that takes an image of the inside of the work booth and a microphone that collects sound. The sensor information 21 is information transmitted from these sensors, the surveillance camera, and the microphone.

The booth information 22 is information on a work booth. The information on a work booth can include information such as an identifier of the work booth, a location of the work booth, a capacity, days of the week on which the work booth is available, and time windows in which the work booth is available.

The reservation information 23 is information on reservations made by users. The reservation information can include information on an identifier of a reserved work booth, a reserved time window, and the number of persons for whom the reservation was made.

The individual user information 24 is information on individual users of the sharing service. When a general user reserves a work booth, the reservation management system 20 notifies this user about information for unlocking the work booth and a guide for using the work booth. The information for unlocking the work booth is, for example, a number for unlocking the door of the work booth. This notification is given, for example, by e-mail.

The authentication system 30 is a system that authenticates a user who uses the sharing service. The authentication system 30 holds corporate user information therein. The corporate user information is information in which a user is registered or deleted by a manager of a corporate user. A corporate user who attempts to use the sharing service is authenticated by the authentication system 30 and then reserves a work booth. When the corporate user reserves the work booth, the authentication system 30 notifies the user about information for unlocking the work booth and a guide for using the work booth. The notification is given, for example, by e-mail.

The charging system 40 is a system that charges a user of the sharing service a usage fee. The charging system 40 holds usage unit fee information therein. The usage unit fee information is information on a fee for using the sharing service per unit time. The unit time may be decided as appropriate by the service provider of the sharing service. The charging system 40 may charge a general user and a corporate user usage fees based on different charging systems.

The booth controller 50 controls devices placed in each work booth. Examples of the devices placed in each work booth include a key, a lighting, a power supply, air-conditioning equipment, a surveillance camera, and a microphone. The booth controller 50 transmits information acquired by the sensors such as the door opening/closing sensor, the illuminance sensor, and the human sensor, the surveillance camera, and the microphone to the reservation management system 20. In a case where the reservation management system 20 determines that an abnormality has occurred in a work booth on the basis of information transmitted from the booth controller 50, the booth controller 50 issues an abnormality warning on the basis of a notification from the reservation management system 20.

The service provider that operates the sharing service provides the sharing service by installing a work booth in a space where a land providing partner has permitted the service provider to install the work booth. The service provider that installs the work booth pays the land providing partner a rent according to the provided space. The service provider collects a usage fee from a user who used the work booth. The service provider divides a profit obtained by collecting usage fees from users among the entities involved with the sharing service. Allocations and rates of the allocations of the profit to the entities are calculated by the service operation management system 10 as described above.

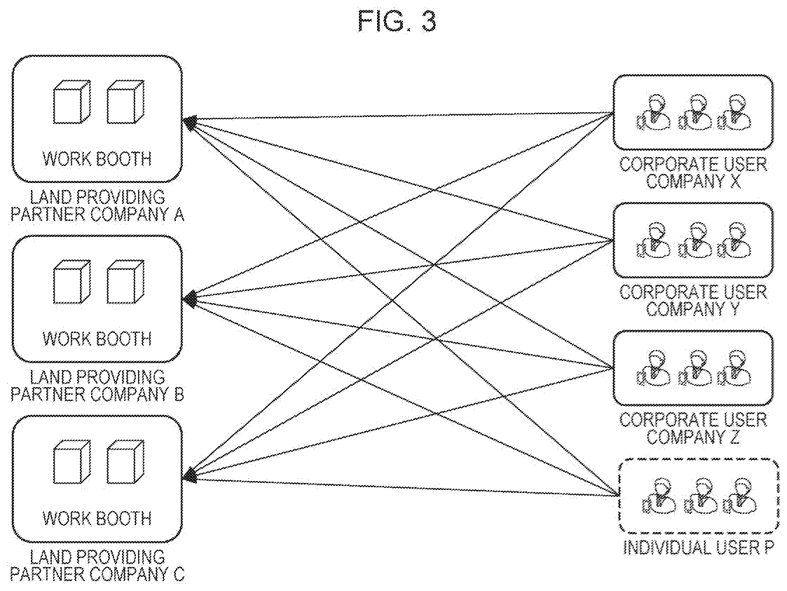

FIG. 3 illustrates a relationship between work booths and users. FIG. 3 shows that work booths installed in spaces provided by three land providing partners can be used by any of corporate users and individual users of the sharing service. Accordingly, the relationship between the work booths and the users is n:n.

Next, specific sharing service operation models are described.

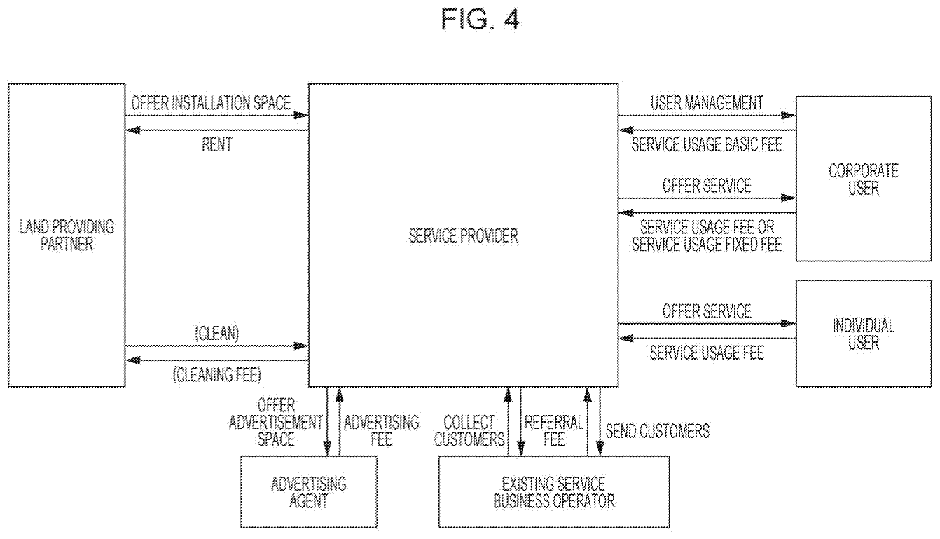

FIG. 4 illustrates an example of a sharing service operation model. FIG. 4 illustrates an example of a service provider direct-sales model.

The service provider is offered a space for installation of a work booth by a land providing partner. The service provider pays the land providing partner a rent according to the offered space. In a case where the service provider requests the land providing partner to clean the work booth, the service provider may pay the land providing partner a fee for the cleaning. In a case where the service provider requests an entity different from the land providing partner to clean the work booth, the service provider pays this entity a cleaning fee. The service provider may request the land providing partner or another entity to replenish articles in the work booth. Furthermore, the service provider may request a security company to guard the work booth.

The service provider offers user management to a corporate user and receives a service usage basic fee for the user management from the corporate user. Furthermore, the service provider receives a service usage fee (or a service usage fixed fee) for offering the service from the corporate user. The service provider receives a service usage fee for offering the service from an individual user.

The service provider may receive an advertising fee for putting an advertisement in an empty space of the work booth from an advertising agent. Furthermore, the service provider may receive or pay a referral fee for exchanging customers with an entity that operates a different sharing service. A revenue including an advertising fee and a referral fee may be divided among plural entities or only usage fees obtained from users may be divided among plural entities.

In the direct-sales model, the service provider gets a profit obtained from end users. However, plural entities may be involved with the sharing service as described above. Accordingly, in the sharing service, a revenue sharing model for dividing a profit obtained from end users among plural entities may be applied.

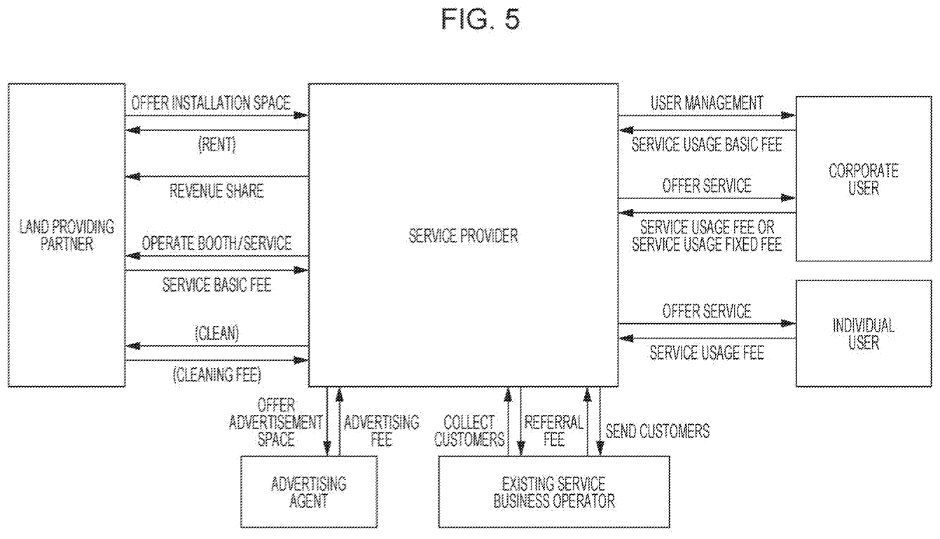

FIG. 5 illustrates an example of a sharing service operation model. FIG. 5 illustrates an example of a revenue sharing model for dividing a profit between the service provider and the land providing partner.

A difference of the revenue sharing model illustrated in FIG. 5 from the direct-sales model lies in that the service provider distributes a profit obtained from end users to the land providing partner (shares a revenue with the land providing partner). The profit is distributed on a predetermined cycle (e.g., every month). The land providing partner pays the service provider a service basic fee for operating the work booth and the sharing service.

Furthermore, the service provider may clean the work booth, and the land providing partner may pay the service provider a cleaning fee for cleaning the work booth.

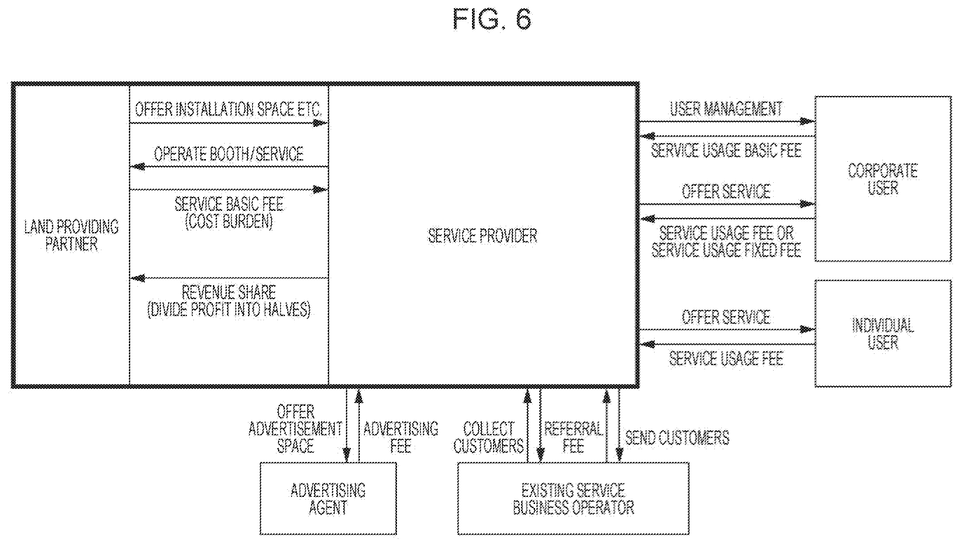

FIG. 6 illustrates an example of a sharing service operation model. FIG. 6 illustrates an example of a revenue sharing model for dividing a profit between the service provider and the land providing partner. In the revenue sharing model illustrated in FIG. 6, the service provider and the land providing partner offer a sharing service in cooperation.

In the revenue sharing model illustrated in FIG. 6, the land providing partner pays the service provider a service basic fee for operating the work booth and the sharing service. In the revenue sharing model illustrated in FIG. 6, a profit obtained from end users are divided between the service provider and the land providing partner. A ratio of allocations of the profit divided between the service provider and the land providing partner is, for example, 1:1.

As described above, various models are conceivable as the sharing service operation model according to the present exemplary embodiment. For example, a sharing service that can be used by corporate users only is also conceivable. In such a sharing service, service usage basic fees monthly paid by the corporate users and service usage fees paid per use of the service become an income of the service provider.

Next, specific examples of a sharing service offering scenario is described.

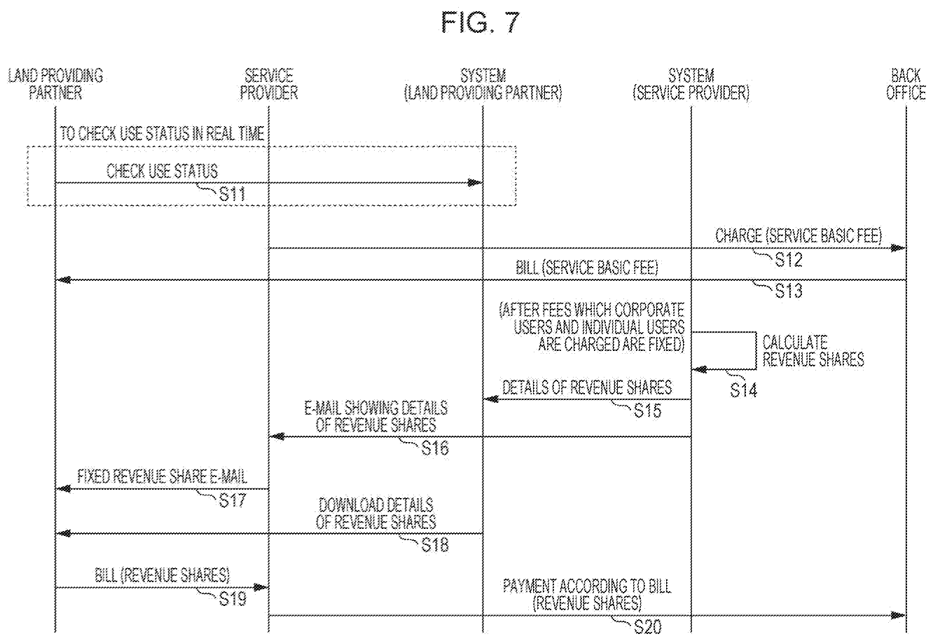

FIG. 7 illustrates an example of a sharing service offering scenario. Specifically, FIG. 7 illustrates an example of a scenario in the revenue sharing model illustrated in FIG. 6.

The land providing partner accesses the system 1 (e.g., the reservation management system 20) to check a status of use of a work booth in real time (step S11). The land providing partner can check, for example, a history of use of each work booth and details of revenue shares. The history of use of each work booth can include a location of the work booth, reservation information, time and date of start of actual use, time and date of end of actual use, and a usage fee. The details of the revenue shares can include information on past months and a current month.

The service provider requests a back office of the service provider to prepare a bill for a basic fee of the sharing service (step S12). The back office issues the bill for the basic fee of the service and sends the bill to a land providing partner manager (step S13).

When fees which corporate users and individual users are charged per predetermined charging unit period (e.g., per month) are fixed, the system 1 (e.g., the service operation management system 10) calculates revenue shares (step S14). The revenue shares are calculated by the system 1 (e.g., the service operation management system 10) on the basis of allocation rates agreed in advance between the service provider and the land providing partner. Although the system 1 calculates the revenue shares when the fees which the corporate users and individual users are charged are fixed in this scenario, the present disclosure is not limited to this example. The system 1 may calculate revenue shares when a corporate user or an individual user makes a reservation to use a work booth.

The system 1 sends details of the revenue shares calculated in step S14 to the system 1 (e.g., the reservation management system 20) used by the land providing partner (step S15) and sends an e-mail showing the details of the revenue shares to a person in charge (e.g., an accounting personnel) in the service provider (step S16).

Upon receipt of the e-mail showing the details of the revenue shares from the system 1, the person in charge in the service provider sends a fixed revenue share e-mail showing the revenue shares to a person in charge (e.g., an accounting personnel) in the land providing partner (step S17). Upon receipt of the fixed revenue share e-mail, the person in charge in the land providing partner downloads the details of the revenue shares from the system 1 (e.g., the reservation management system 20) used by the land providing partner (step S18).

The person in charge in the land providing partner sends a bill to a person in charge in the service provider on the basis of the downloaded details of the revenue shares and the fixed revenue share email sent by the person in charge in the service provider (step S19).

Upon receipt of the bill from the land providing partner, the service provider requests the back office to pay the land providing partner on the basis of the bill (step S20).

Through the above flow, a profit obtained from users can be properly divided between the service provider and the land providing partner.

The service provider may offer the sharing service through sales companies that have their bases in respective geographical regions. In this case, a scenario in which each of the sales companies offers the sharing service in cooperation with a land providing partner is conceivable. In this case, the sharing service may be offered to users (including individual users and corporate users) which the service provider made contracts with or may be offered to user (corporate users) which the sales companies made contracts with by themselves.

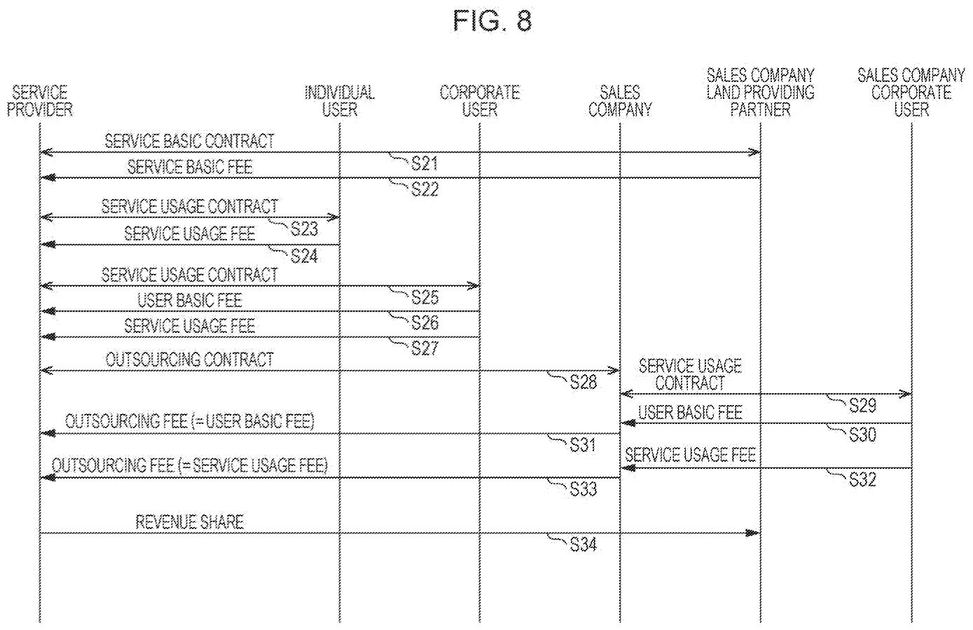

FIG. 8 illustrates an example of a sharing service offering scenario. Specifically, FIG. 8 illustrates an example of a scenario in the case where the service provider provides the sharing service through sales companies in respective geographical regions.

The service provider makes a basic contract of the sharing service with a land providing partner in a geographical region where the service provider wants to offer the sharing service (step S21). A sales company that covers the geographical region where the service provider wants to offer the sharing service may make this basic contract for the service provider. The land providing partner that made the basic contract pays the service provider a service basic fee according to contents of the basic contract (step S22).

The service provider makes a contract for use of the sharing service with an individual user (step S23). The individual user pays the service provider a service usage fee per use of the sharing service (step S24). Furthermore, the service provider makes a contract for use of the sharing service with a corporate user (step S25). The corporate user pays the service provider a user basic fee according to contents of the contract (step S26) and pays the service provider a service usage fee per use of the sharing service (step S27).

The service provider makes an outsourcing contract with each of the sales companies to develop the sharing service (step S28). The sales company that has made the outsourcing contract with the service provider makes a contract for use of the sharing service with a corporate user by itself (step S29). The corporate user that has made the contract with the sales company pay the sales company a user basic fee according to contents of the contract (step S30). The sales company pays the service provider an outsourcing fee corresponding to the user basic fee (step S31). Furthermore, the corporate user pays the sales company a service usage fee per use of the sharing service (step S32). The sales company pays the service provider an outsourcing fee corresponding to the service usage fee (step S33).

Then, the service provider performs revenue sharing with the land providing partner in the geographical region where the sharing service is offered (step S34). As a result of the revenue sharing, a profit is properly divided between the service provider and the land providing partner.

As described above, various sharing service offering scenarios are conceivable. In any scenario, proper calculation of allocations and rates of the allocations of a revenue by the system 1 is necessary for offering a sharing service based on revenue sharing. It is therefore desirable to calculate allocations and rates of allocations of a revenue in consideration of involvement of entities with the sharing service.

In the present exemplary embodiment, the service operation management system 10 calculates allocations and rates of the allocations of a revenue in consideration of involvement of entities with the sharing service.

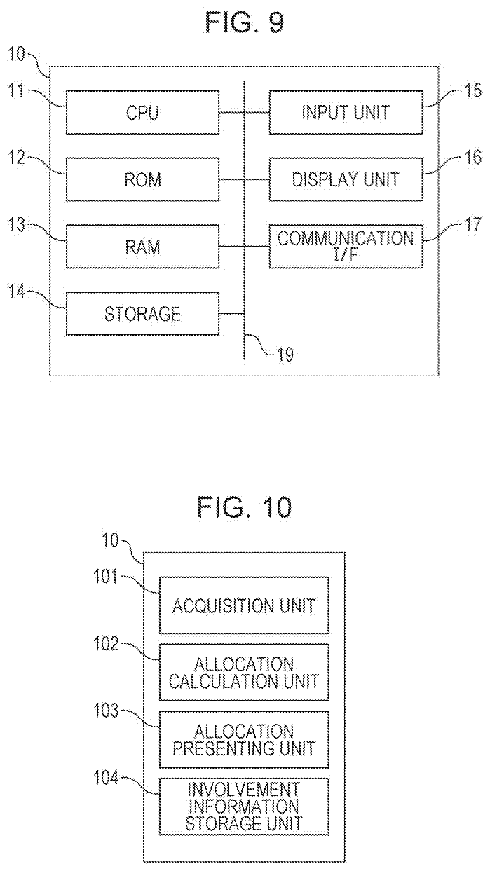

FIG. 9 is a block diagram illustrating a hardware configuration of the service operation management system 10.

As illustrated in FIG. 9, the service operation management system 10 includes a central processing unit (CPU) 11, a read only memory (ROM) 12, a random access memory (RAM) 13, a storage 14, an input unit 15, a display unit 16, and a communication interface (I/F) 17. These constituent elements are communicably connected to one another through a bus 19.

The CPU 11 executes various programs and controls each unit. That is, the CPU 11 reads out a program from the ROM 12 or the storage 14 and executes the program while using the RAM 13 as a working area. The CPU 11 controls the constituent elements and perform various kinds of arithmetic processing in accordance with the programs stored in the ROM 12 or the storage 14. In the present exemplary embodiment, the ROM 12 or the storage 14 stores therein an allocation calculation program for calculating allocations and rates of the allocations of a revenue in consideration of involvement of entities with the sharing service.

The ROM 12 stores therein various programs and various kinds of data. The RAM 13 serves as a working area for temporarily storing therein programs or data. The storage 14 is a storage device such as a hard disk drive (HDD), a solid state drive (SSD), or a flash memory and stores therein various programs including an operating system and various kinds of data.

The input unit 15 includes a pointing device such as a mouse and a keyboard and is used to enter various kinds of information.

The display unit 16 is, for example, a liquid crystal display and displays various kinds of information. The display unit 16 may be a touch panel type display unit that also functions as the input unit 15.

The communication interface 17 is an interface for communication with other apparatuses such as the reservation management system 20 and employs a standard such as the Ethernet (Registered Trademark), FDDI, or Wi-Fi (Registered Trademark).

When executing the allocation calculation program, the service operation management system 10 realizes various functions by using the hardware resources described above. A functional configuration realized by the service operation management system 10 is described below.

Next, a functional configuration of the service operation management system 10 is described.

FIG. 10 is a block diagram illustrating an example of the functional configuration of the service operation management system 10.

As illustrated in FIG. 10, the service operation management system 10 includes, as functional elements, an acquisition unit 101, an allocation calculation unit 102, an allocation presenting unit 103, and an involvement information storage unit 104. These functional elements are realized by execution of the allocation calculation program read out from the ROM 12 or the storage 14 by the CPU 11.

The acquisition unit 101 acquires various kinds of information. For example, the acquisition unit 101 acquires, from an external terminal, an instruction to calculate allocations and rates of the allocations of a revenue. The external terminal may be, for example, a terminal used by a person in charge in the service provider. Furthermore, the acquisition unit 101 acquires, from the involvement information storage unit 104, involvement information on involvement with the sharing service in response to the instruction. The acquisition unit 101 supplies the acquired involvement information to the allocation calculation unit 102.

The allocation calculation unit 102 calculates allocations and rates of allocations to entities involved with the sharing service by referring to the involvement information on the involvement with the sharing service. The allocation calculation unit 102 supplies the calculated allocations and rates of the allocations to the allocation presenting unit 103.

The allocation presenting unit 103 presents the allocations and the rates of the allocations calculated by the allocation calculation unit 102 to the external terminal that has given the instruction to calculate the allocations and the rates of the allocations of the revenue.

The involvement information storage unit 104 stores therein involvement information on involvement with the sharing service. The involvement information storage unit 104 is provided, for example, in the storage 14. The involvement information is, for example, information on involvement of entities participating in the sharing service with the sharing service. The involvement with the sharing service may be determined, for example, by the entities at the start of the service.

The involvement with the sharing service can, for example, change over passage of time from the start of the service. For example, around the start of the service, high initial investment costs such as a cost for installation of a work booth are needed. In view of this, in an initial stage after the start of the service, the allocation calculation unit 102 calculates the allocations and the rates of the allocations so that an allocation to the service provider becomes large. Thereafter, a rate of a cost burden on an entity that bears operating costs such as a system server cost, a cost of the land, and an electricity cost increases. If the cost for installation of the work booth has been recovered over passage of time from the start of the service, the allocation to the service provider may be lowered, and an allocation to an entity that does maintenance and management of the work booth may be increased.

Furthermore, for example, in a case where the service provider requests the land providing partner to clean the work booths, costs such as a cost for a cleaning personnel can change over passage of time from the start of the service. Accordingly, the involvement information may be fixed information or may be information that is regularly revised.

The allocation calculation unit 102 can properly calculate allocations and rates of the allocations according to involvement with the sharing service by calculating the allocations and the rates of the allocations by referring to the involvement information stored in the involvement information storage unit 104.

Next, operation of the service operation management system 10 is described.

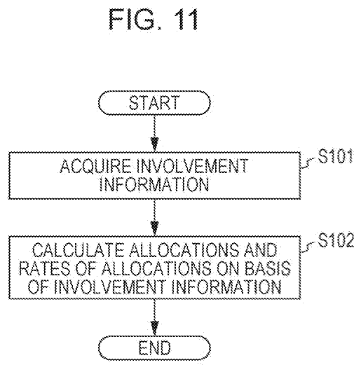

FIG. 11 is a flowchart illustrating a flow of allocation calculation processing performed by the service operation management system 10. To perform the allocation calculation processing, the CPU 11 reads out the allocation calculation program from the ROM 12 or the storage 14, loads the allocation calculation program to the RAM 13, and executes the allocation calculation program.

The CPU 11 acquires involvement information on involvement with the sharing service from the storage 14 in response to an instruction to calculate allocations and rates of the allocations of a revenue (step S101).

Next, the CPU 11 calculates the allocations and the rates of the allocations of the revenue on the basis of the involvement information acquired from the storage 14 (step S102). For example, it is assumed that a service provider and a land providing partner are participating in the sharing service, a ratio of involvement of the service provider to involvement of the land providing partner is 7:3, and the ratio is stored in the storage 14 as involvement information. The CPU 11 calculates allocations of the revenue so that a ratio of the allocations of the revenue becomes 7:3 by referring to the involvement information.

The involvement information is not limited to a ratio of involvement. As described above, the degrees of involvement with the sharing service can change over passage of time from the start of the service. The CPU 11 may calculate allocations and rates of the allocations of the revenue in consideration of an elapsed period from the start of the service.

The involvement information may include information on initial investment costs and running costs of entities (corporations or individuals) participating in the sharing service. The CPU 11 may calculate a proper cost recovery rate on the basis of the involvement information to determine allocations and rates of the allocations of the revenue.

Assume that three parties, specifically, a service provider, a land providing partner, and a maintenance entity are involved with the sharing service. In this case, even if a fee system for charging a fee according to a period of use of the service is changed, the service operation management system 10 automatically determines allocations and rates of the allocations in accordance with a cost burden balance among the three parties stored as the involvement information and a balance agreed in a contract. Since the allocations and the rates of the allocations are determined by the service operation management system 10, the system 1 can properly operate the charging system continuously even if the fee system for charging a fee according to a period of use of the service is changed. The same applies to a case where the same company is in charge of two or more of operation of the service, offering of land, and maintenance.

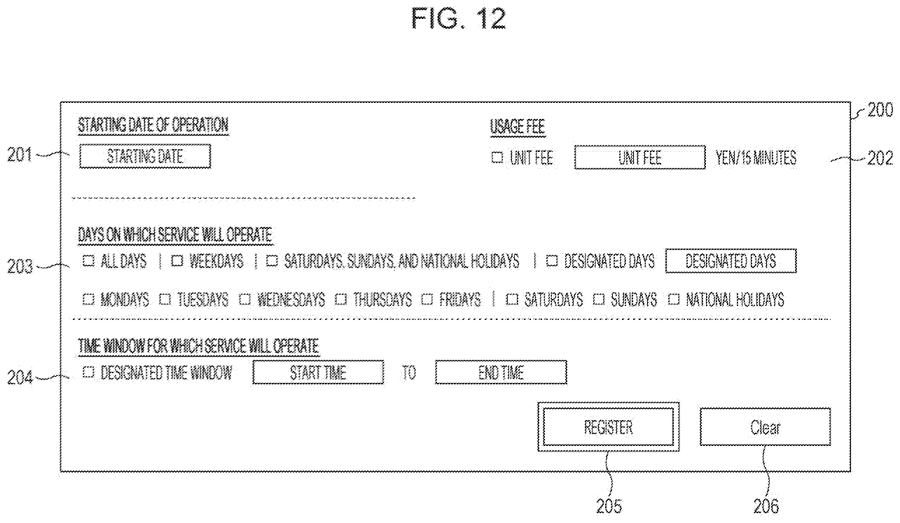

FIG. 12 is an example of a user interface that is offered so that the service operation management system 10 can calculate allocations and rates of the allocations. A user interface 200 illustrated in FIG. 12 is, for example, a user interface displayed on a terminal used by a person in charge in the service provider. The user interface 200 illustrated in FIG. 12 has a region 201 for entering a date of start of operation of the sharing service, a region 202 for entering a unit price which a user who uses the sharing service is charged, a region 203 for entering days on which the service will operate, and a region 204 for entering a time window for which the service will operate. When the person in charge selects a registration button 205, the service operation management system 10 registers involvement information on the basis of information entered in these regions. Then, the service operation management system 10 calculates allocations and rates of the allocations of the revenue on the basis of the registered involvement information. A clear button 206 is a button for deleting the information entered in the regions.

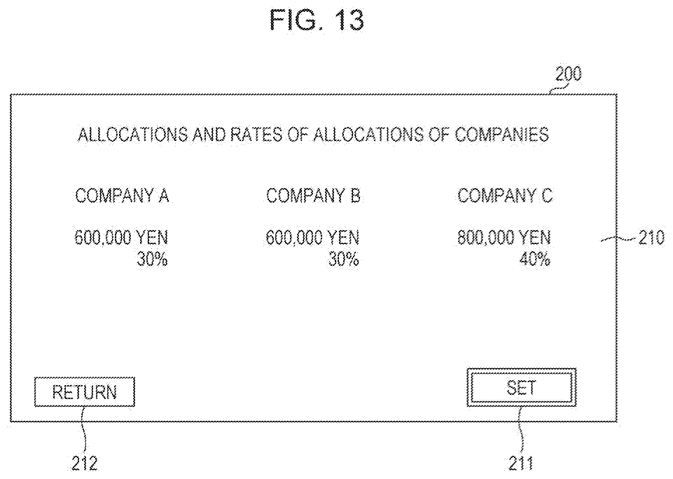

FIG. 13 is an example of a user interface that is offered so that the service operation management system 10 can calculate allocations and rates of the allocations on the basis of the involvement information. The user interface 200 illustrated in FIG. 13 is, for example, a user interface displayed on a terminal used by a person in charge in the service provider as in the case of FIG. 12 and is an example of a user interface displayed on the terminal in a case where the registration button 205 of FIG. 12 is selected.

The user interface 200 illustrated in FIG. 13 has a region 210 where allocations and rates of the allocations of the revenue to the entities are displayed. A setting button 211 is a button by which the person in charge decides to operate the service based on the allocations and the rates of the allocations if there is no problem with the allocations and the rates of the allocations displayed in the region 210. A return button 212 is a button by which the person in charge enters information again on the user interface 200 illustrated in FIG. 12 if there is a problem with the allocations and the rates of the allocations displayed in the region 210. When the setting button 211 is selected, the CPU 11 may send, to persons in charge in the entities, an e-mail showing information on the allocations and rates of the allocations of the revenue to the entities.

The entities participating in the sharing service sometimes conduct a campaign such as a discount campaign to increase the frequency of use of the service. The system 1 (e.g., the service operation management system 10) according to the present exemplary embodiment offers a computer program for allowing the entities to set information on discount. In the present exemplary embodiment, the computer program for allowing the entities to set information on discount is referred to as a discount tool. The discount tool may be realized, for example, by a macro function of spreadsheet software.

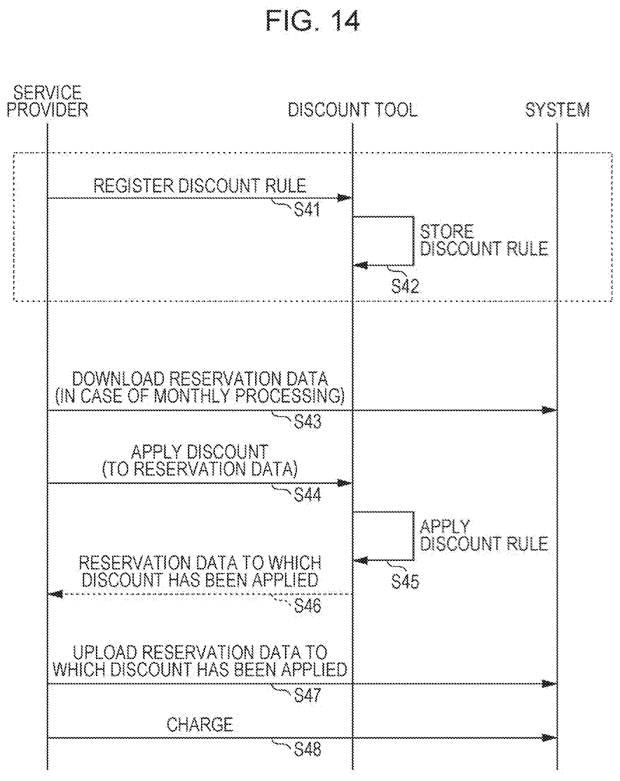

FIG. 14 illustrates an example of a sharing service operation scenario. FIG. 14 illustrates an example of an operation scenario in a case where the service provider discounts a fee for using the sharing service by using the discount tool.

The service provider registers a discount rule in the discount tool offered by the system 1 (e.g., the service operation management system 10) (step S41). The discount tool stores the discount rule entered by the service provider (step S42). The discount rule entered by the service provider is not limited to one, and plural discount rules are applicable in the same period.

The service provider requests the system 1 to download reservation data registered at this point of time (step S43). In a case of monthly processing, a request to download reservation data can be automatically transmitted to the system 1.

The service provider that has downloaded the reservation data from the system 1 transmits the reservation data to the discount tool to apply the discount rule registered in step S41 to the reservation data (step S44). The discount tool applies the discount rule stored in step S42 to the reservation data transmitted from the service provider (step S45). When the discount tool applies the discount rule to the reservation data, the discount tool returns the reservation data to which the discount rule has been applied to the service provider (step S46). The service provider checks the reservation data to which the discount rule has been applied by the discount tool and uploads the reservation data to which the discount rule has been applied to the system 1 if there is no problem (step S47).

When a user who has made a reservation uses a work booth, the service provider charges the system 1 a usage fee (step S48). The usage fee charged by the service provider is a usage fee to which the discount rule has been applied by the discount tool.

Through the flow illustrated in FIG. 14, the service provider can set a discount rule and charge a fee based on the set discount rule.

Parameters set in a case where a discount campaign is conducted are illustrated below. Examples of the discount parameters include time and date, a place, a period, a user attribute, and demand adjustment.

As the time and date parameter, a combination of days of the week on which the discount will be conducted and start and end times of the discount can be set. For example, a parameter for conducting 50% discount all day on Saturday and Sunday and in the morning and evening on weekdays can be set.

As the place parameter, an area or a work booth where the discount will be applied can be set.

As the period parameter, an area or a work booth where the discount will be applied and a period for which the discount will be conducted can be set. For example, a parameter for conducting 50% discount in a newly opened place for two weeks from the opening can be set.

As the user attribute parameter, a user to which the discount will be applied can be set. For example, a parameter for applying 10% discount to a specific user can be set.

As the demand adjustment parameter, for example, a parameter for applying 50% discount to a place where a reservation rate is lower than a predetermined threshold value (e.g., 10%) or there are few people can be set. Furthermore, as the demand adjustment parameter, for example, a parameter for increasing a fee in a place where a reservation rate is higher than a predetermined threshold value (e.g., 80%) or there are many people can be set. Whether the number of people is large or small can be determined, for example, on the basis of positional information of mobile phones, a degree of congestion of radio waves of mobile phones, or information obtained from a surveillance camera or a sensor of other kinds in a city.

In a case where a discount campaign is conducted, the system 1 may manage which entity has conducted the campaign and determine whether or an earnings balance of the other entities is maintained. Furthermore, in a case where an entity sets a marginal profit, when a discount campaign is conducted, the system 1 may keep earnings of the entity that sets the marginal profit from being lowered or make a degree of reduction or a rate of reduction of the earnings smaller than an entity that does not set a marginal profit instead of equally lowering earnings of all entities.

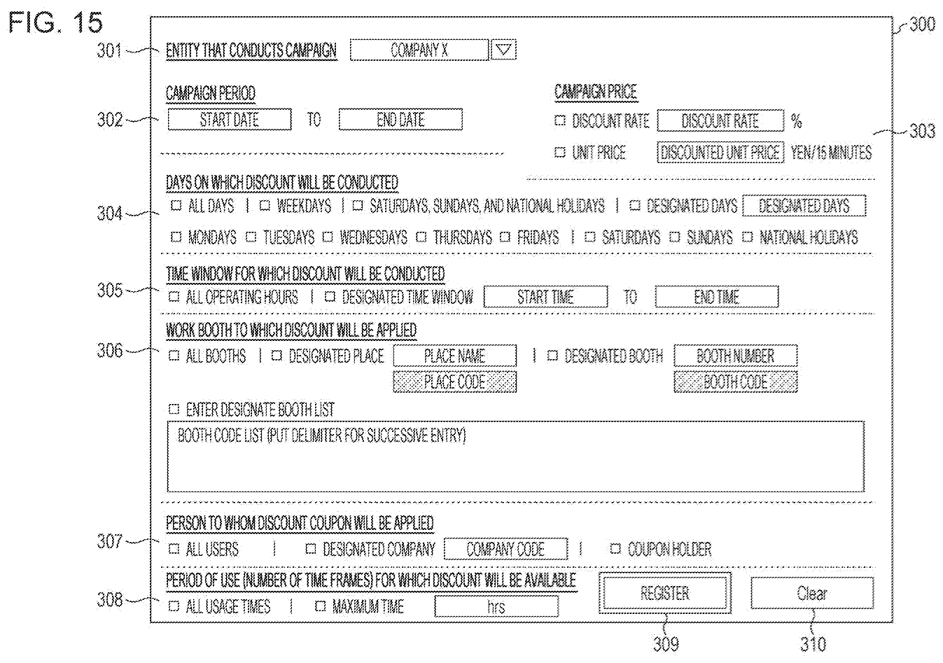

FIG. 15 illustrates an example of a user interface of the discount tool offered by the service operation management system 10. A user interface 300 of the discount tool illustrated in FIG. 15 is, for example, a user interface displayed on a terminal used by a person in charge in the service provider. The user interface 300 of the discount tool illustrated in FIG. 15 has a region 301 for selecting an entity that conducts a discount campaign, a region 302 for entering a period for which the discount campaign will be conducted, a region 303 for entering a discount rate or a discounted unit price, a region 304 for designating days on which the discount will be conducted, a region 305 for entering a time window for which the discount will be conducted, a region 306 for entering a work booth to which the discount will be applied, a region 307 for selecting a person to whom a discount coupon will be applied, and a region 308 for entering a period of use for which the discount will be available. When the person in charge selects a registration button 309, the service operation management system 10 calculates allocations and rates of the allocations of a revenue after the discount on the basis of information entered in the regions and the involvement information. A clear button 310 is a button for deleting the information entered in the regions.

The discount tool may restrict contents of discount depending on an entity that attempts to conduct a discount campaign. For example, in a case where a land providing partner attempts to conduct a discount campaign, the discount tool may restrict a target of the discount campaign to a work booth installed on land offered by this land providing partner.

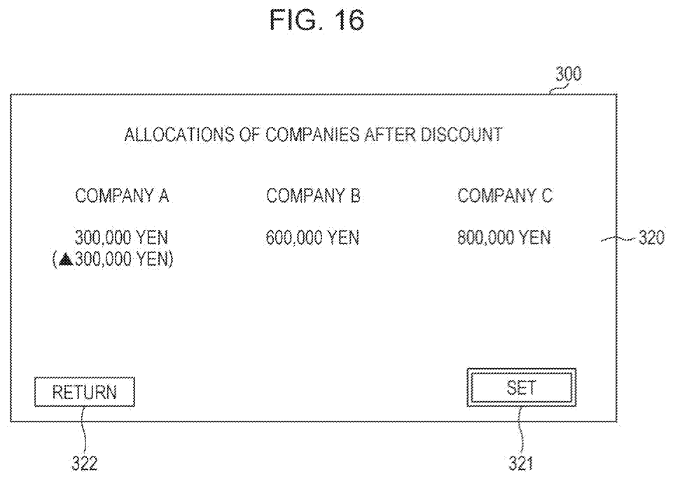

FIG. 16 illustrates an example of a user interface of the discount tool offered by the service operation management system 10. The user interface 300 of the discount tool illustrated in FIG. 16 is, for example, a user interface of a discount tool displayed on a terminal used by a person in charge in the service provider as in the case of FIG. 15. The user interface 300 of the discount tool illustrated in FIG. 16 is an example of a user interface of the discount tool displayed on the terminal in a case where the registration button 309 of FIG. 15 is selected.

The user interface 300 of the discount tool illustrated in FIG. 16 has a region 320 where allocations and rates of the allocations of a revenue after discount to entities. In the example of FIG. 16, only an allocation to company A decreases in a case where a discount campaign is set. A setting button 321 is a button by which the person in charge determines that the service is operated on the basis of the allocations and the rates of the allocations if there is no problem with the allocations and the rates of the allocations displayed in the region 320. A return button 322 is a button by which the person in charge enters information again on the user interface 300 of the discount tool illustrated in FIG. 15 if there is a problem with the allocations and the rates of the allocations displayed in the region 320. When the setting button 321 is selected, the CPU 11 may send, to a person in charge in each entity, an e-mail showing information on the allocations and the rates of the allocations of the revenue after discount to the entities.

The service operation management system 10 allows entry of information on a discount campaign by offering the user interfaces of the discount tool illustrated in FIGS. 15 and 16. Furthermore, the service operation management system 10 can calculate and present allocations and rates of the allocations of a revenue after application of discount by offering the user interfaces of the discount tool illustrated in FIGS. 15 and 16.

Setting of a discount campaign can be made per predetermined period (e.g., per month). A campaign price can be set for use of a discount target set in usage data in a target month. In a case where a user uses the service beyond a time window for which discount is applied, a campaign price is applied only to use in the time window for which the discount is applied. In a case where a maximum value is set on a period for which a campaign price is applied, an individual user is charged not a campaign price but a normal price for a period exceeding the maximum value when a total period of use exceeds the maximum value.

The system 1 according to the present exemplary embodiment can operate the sharing service based on a proper fee system for entities participating in a platform of the sharing service. In a case where a place is registered as a place to be reserved in a database managed in the system 1 according to the present exemplary embodiment, a mechanism of revenue sharing is applied. Therefore, the system 1 according to the present exemplary embodiment can realize operation from registration of a place to be shared to profit allocation.

An entity that operates a sharing service can be changed in the middle of operation of the sharing service. In a case where the entity that operates the sharing service is changed, the system 1 may give each entity a notification about recalculation of allocations and rates of the allocations of a revenue. The notification may be given, for example, at a timing at which a name of an entity registered in the system 1 is changed. By giving the notification, the system 1 can prompt an entity that newly participates in the service and an entity that is participating in the service to consult with each other about allocations and rates of the allocations of a revenue. By suspending start of the service until the allocations and the rates of the allocations of the revenue are decided, an issue about the allocations and the rates of the allocations of the revenue is not postponed, and stable operation of the service can be achieved. If a date on which the sharing service will be resumed has been determined, the system 1 may prompt the entities to decide the allocations and the rates of the allocations of the revenue by this date. If an agreement cannot be obtained about the allocations and the rates of the allocations of the revenue newly calculated by the changed entity from other entities involved with the sharing service, the system 1 may suspend the operation of the sharing service until the agreement is obtained. In a case where at least one of the entities that operate the sharing service is changed, the system 1 can avoid conflict among the entities in terms of price after start of operation of the service by suspending the sharing service until an agreement is reach about new allocations.

Although a work booth has been described as an example of a shared space in the above exemplary embodiment, a target of the present disclosure is not limited to a work booth. Examples of a sharing service with which plural entities are involved include a service for sharing a rental conference room or a table at a restaurant, a car sharing service combining a parking area and a rental car, and food delivery service in which different entities are in charge of cooking and delivery, respectively. The present disclosure in which allocations are calculated on the basis of involvement information is also applicable to division of a revenue among plural entities in these services.

The allocation calculation processing executed by reading software (program) by a CPU in the above exemplary embodiment may be executed by a processor of various kinds other than a CPU. The processor is, for example, a Programmable Logic Circuit such as a Field Programmable Gate Array (FPGA) that can be programmed after manufacturing or a dedicated electric circuit, such as an Application Specific Integrated Circuit (ASIC), which is a processor having circuit configuration designed exclusively for execution of specific processing. The allocation calculation processing may be executed by one of these various kinds of processors or may be executed by a combination of two or more processors of the same kind or different kinds (e.g., a combination of plural FPGAs or a combination of CPU and FPGA). A hardware structure of the processor of various kinds is, more specifically, an electric circuit combining circuit elements such as semiconductor elements.

Although a program for the allocation calculation processing is stored (installed) in advance in a ROM or a storage in the above exemplary embodiment, this configuration is not restrictive. The program may be offered while being recorded in a recording medium such as a Compact Disk Read Only Memory (CD-ROM), a Digital Versatile Disk Read Only Memory (DVD-ROM), or a Universal Serial Bus (USB) memory. The program may be downloaded from an external device over a network.

The operations of the processor in the above exemplary embodiment may be performed by one processor or plural processors in collaboration which are located physically apart from each other but may work cooperatively. The order of operations of the processor is not limited to one described in the embodiment above, and may be changed.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
calculate allocations of a profit from a service to a plurality of entities involved in provision of the service by referring to involvement information stored in a memory, the involvement information indicating involvement of each of the plurality of entities in the provision of the service, and
output the calculated allocations.

2. The information processing apparatus according to claim 1, wherein
the involvement information includes information on involvement duration in the provision of the service.

3. The information processing apparatus according to claim 2, wherein
the involvement information further includes information on involvement in an initial investment to the service.

4. The information processing apparatus according to claim 2, wherein
the involvement information further includes information on involvement in running cost of the service.

5. The information processing apparatus according to claim 3, wherein
the involvement information further includes information on involvement in running cost of the service.

6. The information processing apparatus according to claim 1, wherein the processor is configured to:
calculate the allocations of the profit to the plurality of entities by further referring to information on a discount offered by one or more of the plurality of entities on a user fee for the service.

7. The information processing apparatus according to claim 6, wherein
calculate the allocations of the profit to the plurality of entities by further referring to information on a marginal profit set by one or more of the plurality of entities, so that a profit allocated to the one or more of the plurality of entities does not become smaller than the set marginal profit.

8. The information processing apparatus according to claim 1, wherein the processor is configured to
provide a user interface for setting the involvement information, and
receive settings of the involvement information from the user interface.

9. The information processing apparatus according to claim 1, wherein
the processor is configured to provide a user interface for setting a discount on a user fee for the service.

10. The information processing apparatus according to claim 9, wherein
the user interface has a field for setting an entity that is setting the discount.

11. The information processing apparatus according to claim 1, wherein the processor is configured to
in response to the involvement information being updated by a change to one or more of the plurality of entities, recalculate the allocations by referring to the updated involvement information.

12. The information processing apparatus according to claim 11, wherein the processor is configured to
give each of the plurality of entities a notification about the recalculation of the allocations.

13. The information processing apparatus according to claim 11, wherein the processor is configured to
suspend the provision of the service unless an agreement is reached on the recalculated allocations.

14. The information processing apparatus according to claim 12, wherein the processor is configured to
suspend the operation of the service unless an agreement is reached on the recalculated allocations.

15. The information processing apparatus according to claim 1,
wherein the service is a sharing service of a sharing target among a plurality of users by time windows.

16. The information processing apparatus according to claim 15,
wherein the sharing target is a space.

17. The information processing apparatus according to claim 8,
wherein the service is a sharing service of a sharing target among a plurality of users by time windows.

18. The information processing apparatus according to claim 17,
wherein the service is a sharing service of a sharing target among a plurality of users by time windows.

19. A non-transitory computer readable medium storing a program causing a computer to execute a process for information processing, the process comprising:
calculating allocations of a profit from a service to a plurality of entities involved in provision of the service by referring to involvement information stored in a memory, the involvement information indicating involvement of each of the plurality of entities in the provision of the service, and
outputting the calculated allocations.

20. An information processing apparatus comprising:
means for calculating allocations of a profit from a service to a plurality of entities involved in provision of the service by referring to involvement information stored in a memory, the involvement information indicating involvement of each of the plurality of entities in the provision of the service, and
means for outputting the calculated allocations.
